(19) United States
(12) Patent Application Publication
(10) Pub. No.: US 2022/0319191 A1
(43) Pub. Date: Oct. 6, 2022

(54) CONTROL DEVICE AND CONTROL METHOD FOR MOBILE OBJECT, AND STORAGE MEDIUM

(71) Applicant: HONDA MOTOR CO., LTD., Tokyo (JP)

(72) Inventors: Akira KANEHARA, Wako-shi (JP); Misako YOSHIMURA, Wako-shi (JP)

(21) Appl. No.: 17/704,635

(22) Filed: Mar. 25, 2022

(30) Foreign Application Priority Data
Mar. 30, 2021 (JP) 2021-058441

(51) Int. Cl. G06V 20/58; B60W 50/14

(52) U.S. Cl. CPC G06V 20/58; B60W 50/14; B60W 2420/42; B60W 2554/4049; B60W 2554/4048; B60W 2050/146

(57) ABSTRACT

A control device of a mobile object including an imaging device attached with a lens having a wide angle of view is given. The control device acquires, from the imaging device, an image acquired by imaging an outside of the mobile object, and detects a target object through image recognition, based on the acquired image. The control device performs a distortion reduction process for reducing a distortion of the image on a partial area in the image acquired from the imaging device, in accordance with the detection result. The partial area is an area whose center is set to be either a detection position of the target object or a vicinity of the detection position. The control device recognizes the outside of the mobile object, based on an image that has been acquired by the distortion reduction process.

### CROSS-REFERENCE TO RELATED APPLICATION(S)

This application claims priority to and the benefit of Japanese Patent Application No. 2021-058441 filed on Mar. 30, 2021, the entire disclosure of which is incorporated herein by reference.

### BACKGROUND OF THE INVENTION

### Field of the Invention

The present invention relates to a control technique of a mobile object.

### Description of the Related Art

An outside of a vehicle is recognized from an image acquired by capturing surroundings of the vehicle, and a recognition result is used for control in driving assistance or the like. In such a situation, in order to enlarge a detection range, it is also conceivable that a camera having a wide angle of view, such as a fisheye lens, is used. However, with such a camera, wide-angle images can be acquired, but the acquired images are distorted. Hence, in a case where an object detection technique premised upon an image without a distortion that is acquired from a normal camera is applied, detection accuracy may suffer. Japanese Patent Laid-open No. 2008-48443 discloses a technique of performing a distortion reduction process on a distorted image, and detecting an object with use of an image that has been corrected.

In order to achieve appropriate driving assistance control or automated driving control, based on a recognition result of the outside of a mobile object such as a vehicle, there is a demand for acquiring precise information related to an object stationary or moving in the surroundings of the mobile object. However, unless the distortion reduction process is appropriately performed on an image acquired from an imaging device attached with a lens having a wide angle of view such as a fisheye lens, information related to an object present in the surroundings of the mobile object cannot be appropriately acquired, in some cases.

### SUMMARY OF THE INVENTION

The present invention provides a technique for accurately acquiring information related to an object in surroundings of a mobile object from an image acquired by an imaging device attached with a lens having a wide angle of view.

According to one aspect of the present invention, there is provided a control device of a mobile object including an imaging device attached with a lens having a wide angle of view, the control device comprising: an image acquisition unit configured to acquire, from the imaging device, an image that has been acquired by imaging an outside of the mobile object; a detection unit configured to detect a target object through image recognition, based on the image that has been acquired from the imaging device; a processing unit configured to perform a distortion reduction process for reducing a distortion of the image on a partial area in the image that has been acquired from the imaging device, in accordance with a detection result of the detection unit, the partial area being an area whose center is set to be including either a detection position of the target object or a vicinity of the detection position set as a center; and a recognition unit configured to recognize the outside of the mobile object, based on an image that has been acquired by the distortion reduction process.

Further features of the present invention will become apparent from the following description of exemplary embodiments (with reference to the attached drawings).

### BRIEF DESCRIPTION OF THE DRAWINGS

FIG. 1 is a block diagram illustrating a configuration example of a vehicle according to one embodiment;

FIGS. 2A to 2C are schematic diagrams each illustrating an imaging range of a camera according to one embodiment;

FIG. 3 is a schematic diagram for describing a distortion reduction process according to one embodiment;

FIG. 4 is a flowchart illustrating a procedure of a process performed by a control device according to one embodiment; and

FIG. 5 is a flowchart illustrating a procedure of a process performed by the control device according to another embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

<Configuration>

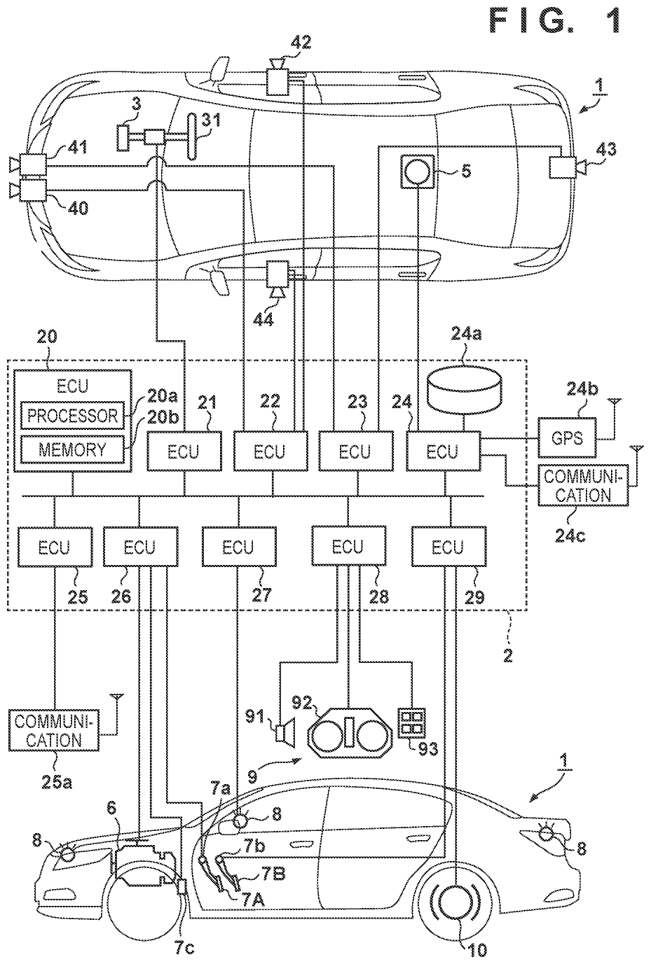

FIG. 1 is a block diagram of a vehicle 1 according to one embodiment of the present invention. In FIG. 1, an outline of the vehicle 1 is illustrated in a plan view and in a side view. The vehicle 1 is, for example, a four-wheeled passenger vehicle of a sedan type. The vehicle 1 may be such a four-wheeled vehicle, a two-wheeled vehicle, or any other types of vehicle.

The vehicle 1 includes a vehicle control device 2 (hereinafter, simply referred to as a control device 2) that controls the vehicle 1. The control device 2 includes a plurality of electronic control units (ECUs) 20 to 29 communicably connected through an in-vehicle network. Each ECU includes a processor such as a central processing unit (CPU), a memory such as a semiconductor memory, an interface with an external device, and the like. In the memory, programs executed by the processor, data used for processing by the processor, and the like are stored. Each ECU may include a plurality of processors, memories, interfaces, and the like. For example, the ECU 20 includes one or more processors 20a and one or more memories 20b. The processor 20a executes commands included in a program stored in the memory 20b, and so a process is executed by the ECU 20. Instead of this, the ECU 20 may include an integrated circuit such as an application specific integrated circuit (ASIC) dedicated to performing a process by the ECU 20. A similar configuration applies to the other ECUs.

Hereinafter, functions and the like assigned to the respective ECUs 20 to 29 will be described. Note that the number of ECUs and functions to be assigned can be designed as appropriate, and can be subdivided or integrated as compared with the present embodiment.

The ECU 20 conducts control related to automated traveling of the vehicle 1. In automated driving, at least one of steering and acceleration or deceleration of the vehicle 1 is automatically controlled. The automated traveling by the ECU 20 may include automated traveling that does not need the driver's operation for traveling (which can also be referred to as automated driving) and automated traveling for assisting the driver's operation for traveling (which can also be referred to as driving assistance).

The ECU 21 controls an electric power steering device 3. The electric power steering device 3 includes a mechanism that steers front wheels in accordance with a driver's driving operation (steering operation) on a steering wheel 31. In addition, the electric power steering device 3 includes a motor that exerts a driving force for assisting the steering operation and automatically steering the front wheels, a sensor that detects a steering angle, and the like. In a case where the driving state of the vehicle 1 is the automated driving, the ECU 21 automatically controls the electric power steering device 3 in response to an instruction from the ECU 20, and controls the advancing direction of the vehicle 1.

The ECUs 22 and 23 control a detection unit that detects a surrounding situation of the vehicle, and perform information processing on a detection result. The vehicle 1 includes one standard camera 40 and four fisheye cameras 41 to 44, each serving as the detection unit that detects a surrounding situation of the vehicle. The standard camera 40 and the fisheye cameras 42 and 44 are connected with the ECU 22. The fisheye cameras 41 and 43 are connected with the ECU 23. The ECUs 22 and 23 analyze images that have been captured by the standard camera 40 and the fisheye cameras 41 to 44, and are capable of extracting an outline of a target object or a lane division line (a white line or the like) of a lane on a road.

Each of the fisheye cameras 41 to 44 is a camera attached with a fisheye lens, and is an example of an imaging device attached with a lens having a wide angle of view. A wide-angle image can be captured, but a larger distortion occurs in the acquired image (than an image captured by the standard camera). Hereinafter, the configuration of the fisheye camera 41 will be described. The other fisheye cameras 42 to 44 may have a similar configuration. The angle of view of the fisheye camera 41 is wider than the angle of view of the standard camera 40. Therefore, the fisheye camera 41 is capable of capturing a wider area than the area of the standard camera 40. The image that has been captured by the fisheye camera 41 has a distortion larger than the image that has been captured by the standard camera 40. For this reason, before analyzing the image that has been captured by the fisheye camera 41, the ECU 23 may perform a conversion process for reducing a distortion (hereinafter, referred to as “a distortion reduction process”) on the image. On the other hand, before analyzing the image that has been captured by the standard camera 40, the ECU 22 does not have to perform the distortion reduction process on the image. In this manner, the standard camera 40 is an imaging device that captures an image not to be subject to the distortion reduction process, whereas the fisheye camera 41 is an imaging device that captures an image to be subject to the distortion reduction process. Instead of the standard camera 40, any of other imaging devices may be used, as long as it captures an image not to be subject to the distortion reduction process, for example, a camera attached with a wide-angle lens or a telephoto lens.

The standard camera 40 is attached at the center in a front part of the vehicle 1, and captures an image of a surrounding situation ahead of the vehicle 1. The fisheye camera 41 is attached at the center in the front part of the vehicle 1, and captures an image of a surrounding situation ahead of the vehicle 1. In FIG. 1, the standard camera 40 and the fisheye camera 41 are illustrated to be aligned in a horizontal direction. However, the arrangement of the standard camera 40 and the fisheye camera 41 is not limited to this, and for example, may be aligned in a vertical direction. In addition, at least one of the standard camera 40 and the fisheye camera 41 may be attached at a front part of a roof of the vehicle 1 (for example, on a vehicle inner side of the windshield). The fisheye camera 42 is attached at the center in a right side part of the vehicle 1, and captures an image of a surrounding situation on a right side of the vehicle 1. The fisheye camera 43 is attached at the center in a rear part of the vehicle 1, and images a surrounding situation behind the vehicle 1. The fisheye camera 44 is attached at the center in a left side part of the vehicle 1, and images a surrounding situation on a left side of the vehicle 1.

The type, the number, and the attached position of the cameras included in the vehicle 1 are not limited to the above-described examples. In addition, the vehicle 1 may include a light detection and ranging (LiDAR) or a millimeter wave radar, as the detection unit for detecting a target object in the surroundings of the vehicle 1 and for measuring a distance to the target object.

The ECU 22 controls the standard camera 40 and the fisheye cameras 42 and 44, and performs information processing on detection results. The ECU 23 controls the fisheye cameras 41 and 43, and performs information processing on detection results. The detection units that respectively detect the surrounding situations of the vehicle are divided into two systems, and therefore the reliability of the detection results can be improved.

The ECU 24 controls a gyro sensor 5, a global positioning system (GPS) sensor 24b, and a communication device 24c, and performs information processing on a detection result or a communication result. The gyro sensor 5 detects a rotational motion of the vehicle 1. The course of the vehicle 1 can be determined from the detection result of the gyro sensor 5, the wheel speed, and the like. The GPS sensor 24b detects the current location of the vehicle 1. The communication device 24c conducts wireless communication with a server that provides map information and traffic information, and acquires these pieces of information. The ECU 24 is capable of accessing a map information database 24a constructed in a memory, and the ECU 24 searches for a route and the like from the current location to a destination. The ECU 24, the map database 24a, and the GPS sensor 24b constitute a so-called navigation device.

The ECU 25 is provided with a communication device 25a for inter-vehicle communication. The communication device 25a conducts wireless communication with another vehicle in the surroundings to exchange information between the vehicles.

The ECU 26 controls a power plant 6. The power plant 6 is a mechanism that outputs a driving force for rotating driving wheels of the vehicle 1, and includes, for example, an engine and a transmission. For example, the ECU 26 controls the output from the engine in accordance with the driver's driving operation (accelerator operation or acceleration operation) that has been detected by an operation detection sensor 7a provided on an accelerator pedal 7A, and switches the gear ratio of the transmission, based on information such as the vehicle speed that has been detected by a vehicle speed sensor 7c. When the driving state of the vehicle 1 is the automated driving, the ECU 26 automatically controls the power plant 6 in response to an instruction from the ECU 20, and controls the acceleration or deceleration of the vehicle 1.

The ECU 27 controls lighting devices (headlights, taillights, and the like) including direction indicators 8 (blinkers). In the example of FIG. 1, the direction indicator 8 is provided in the front part, the door mirror, and the rear part of the vehicle 1.

The ECU 28 controls an input and output device 9. The input and output device 9 outputs information to the driver, and accepts an input of information from the driver. A sound output device 91 notifies the driver of information by sound. A display device 92 notifies the driver of information by displaying an image. The display device 92 is arranged, for example, in front of a driver's seat, and constitutes an instrument panel or the like. Note that, although the sound and the display have been given as examples here, information may be notified by vibration or light. In addition, notification of information may be provided by using a combination of some of the sound, the display, the vibration, and the light. Furthermore, the combination or the notification mode may vary in accordance with a level (for example, the degree of urgency) of information that should be notified. An input device 93 is a switch group, which is arranged at a position where the driver is able to operate it, and with which the driver gives an instruction to the vehicle 1. However, the input device 93 may also include a voice input device.

The ECU 29 controls a brake device 10 and a parking brake (not illustrated). The brake device 10 is, for example, a disc brake device, is provided on each wheel of the vehicle 1, and applies resistance to the rotations of the wheels to decelerate or stop the vehicle 1. The ECU 29 controls working of the brake device 10 in response to the driver's driving operation (brake operation) that has been detected by an operation detection sensor 7b provided on a brake pedal 7B, for example. When the driving state of the vehicle 1 is the automated driving, the ECU 29 automatically controls the brake device 10 in response to an instruction from the ECU 20, and controls the deceleration and stop of the vehicle 1. The brake device 10 and the parking brake are also capable of working to maintain a stopped state of the vehicle 1. In addition, in a case where the transmission of the power plant 6 is provided with a parking lock mechanism, such a parking lock mechanism is also capable of working to maintain the stopped state of the vehicle 1.

<Imaging Range>

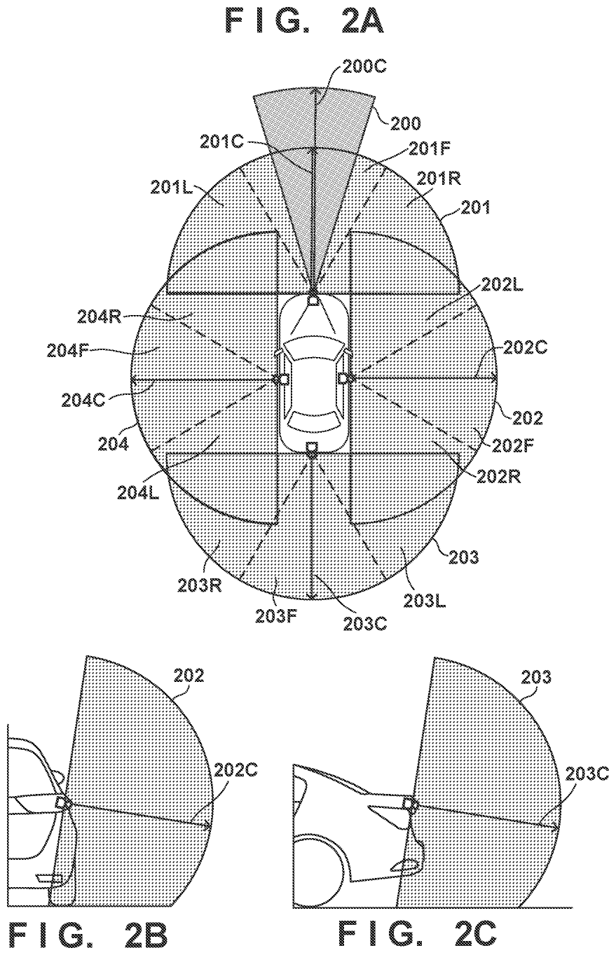

Next, imaging ranges of the standard camera 40 and the fisheye cameras 41 to 44 will be described with reference to FIGS. 2A to 2C. FIG. 2A illustrates an imaging range in a horizontal direction of each camera, FIG. 2B illustrates an imaging range in a vertical direction of the fisheye camera 42 attached at the right side part of the vehicle 1, and FIG. 2C illustrates an imaging range in the vertical direction of the fisheye camera 43 attached at the rear part of the vehicle 1.

First, the imaging ranges in a plan view of the vehicle 1 (that is, the horizontal direction of the vehicle 1) will be described with reference to FIG. 2A. The standard camera 40 images scenery included in an imaging range 200. An imaging center 200C of the standard camera 40 faces directly forward the vehicle 1. A horizontal angle of view of the standard camera 40 may be smaller than 90 degrees, and may be, for example, approximately 45 degrees or approximately 30 degrees.

The fisheye camera 41 images scenery included in an imaging range 201. An imaging center 201C of the fisheye camera 41 faces directly forward the vehicle 1. The fisheye camera 42 images scenery included in an imaging range 202. An imaging center 202C of the fisheye camera 42 faces directly toward a right side of the vehicle 1. The fisheye camera 43 images scenery included in an imaging range 203. An imaging center 203C of the fisheye camera 43 faces directly rearward the vehicle 1. The fisheye camera 44 images scenery included in an imaging range 204. An imaging center 204C of the fisheye camera 44 faces directly toward a left side of the vehicle 1. The horizontal angle of views of the fisheye cameras 41 to 44 may be, for example, larger than 90 degrees, larger than 150 degrees, larger than 180 degrees, or, for example, approximately 180 degrees. FIG. 2A illustrates an example in which the horizontal angle of views of the fisheye cameras 41 to 44 are each 180 degrees.

The imaging range 201 can be divided into an area 201L on a diagonally forward left side of the vehicle 1, an area 201F on a directly forward side of the vehicle 1, and an area 201R on a diagonally forward right side of the vehicle 1. The imaging range 202 can be divided into an area 202L on a diagonally forward right side of the vehicle 1, an area 202F on a directly right side of the vehicle 1, and an area 202R on a diagonally rearward right side of the vehicle 1. The imaging range 203 can be divided into an area 203L on a diagonally rearward right side of the vehicle 1, an area 203F on a directly rear side of the vehicle 1, and an area 203R on a diagonally rearward left side of the vehicle 1. The imaging range 204 can be divided into an area 204L on a diagonally rearward left side of the vehicle 1, an area 204F on a directly left side of the vehicle 1, and an area 204R on a diagonally forward left side of the vehicle 1. The imaging range 201 may be equally divided into the three areas 201L, 201F, and 201R (that is, the angles of views of the respective areas are made equal to one another). The other imaging ranges 202 to 204 each may also be equally divided into three areas.

The standard camera 40 and the fisheye cameras 41 to 44 have the imaging ranges 200 to 204 as described above, so the directly forward direction and the four oblique directions of the vehicle 1 are included in the imaging ranges of the two individual cameras. Specifically, the directly forward side of the vehicle 1 is included in both the imaging range 200 of the standard camera 40 and the area 201F of the imaging range 201 of the fisheye camera 41. The diagonally forward right side of the vehicle 1 is included in both the area 201R of the imaging range 201 of the fisheye camera 41 and the area 202L of the imaging range 202 of the fisheye camera 42. The same applies to the other three oblique directions of the vehicle 1.

Next, an imaging range in the vertical direction of the vehicle 1 will be described with reference to FIGS. 2B and 2C. In FIG. 2B, the imaging range in the vertical direction of the fisheye camera 42 will be described, and in FIG. 2C, the imaging range in the vertical direction of the fisheye camera 43 will be described. The same may apply to the imaging ranges in the vertical direction of the other fisheye cameras 41 and 44.

The angle of view in the vertical direction of the fisheye cameras 41 to 44 may be, for example, larger than 90 degrees, larger than 150 degrees, larger than 180 degrees, or, for example, approximately 180 degrees. FIGS. 2B and 2C each illustrate an example in which the angles of view in the vertical direction of the fisheye cameras 41 to 44 are each 180 degrees. In the illustrated example, the imaging center 203C of the fisheye camera 43 faces a lower side (toward the ground side) than a direction parallel to the ground. Instead of this, the imaging center 203C of the fisheye camera 43 may face a direction parallel to the ground, or may face an upper side than the direction parallel to the ground (toward an opposite side of the ground). Further, the imaging centers 201C to 204C of the respective fisheye cameras 41 to 44 may face different directions from one another in the vertical direction.

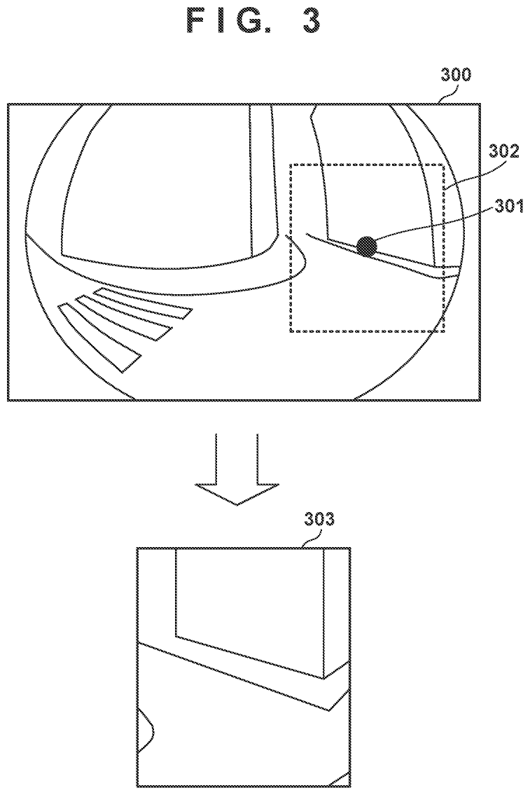

The distortion reduction process of the images that have been captured by the fisheye cameras 41 to 44 will be described with reference to FIG. 3. An image 300 is an image of scenery on the right side of the vehicle 1 that has been captured by the fisheye camera 42. As illustrated, the image 300 has a significant distortion particularly in peripheral parts.

The ECU 22 connected with the fisheye camera 42 performs the distortion reduction process on the image 300. Specifically, the ECU 22 sets one point in the image 300 as a correction center point 301. The ECU 22 cuts out a partial area (a rectangular area 302) having the correction center point 301 as the center, from the image 300. The ECU 22 performs the distortion reduction process on the area 302, and generates an image 303 in which the distortion has been reduced. In the distortion reduction process, the distortion is reduced more, as it is closer to the correction center point 301, and the distortion is not reduced or the distortion is increased, as it is farther from the correction center point 301. Therefore, in some embodiments, the ECU 22 sets the correction center point 301 in an area desired to focus on in the surrounding environment of the vehicle 1, and generates an image in which the distortion has been reduced for such an area.

<Process>

As described with reference to FIG. 3, in images acquired by imaging the outside of the vehicle 1 with the fisheye cameras 41 to 44, each of which is an example of an imaging device attached with a lens having a wide angle of view, a large distortion occurs particularly in peripheral parts. A model for outside recognition, such as object recognition or road recognition, prepared for an image acquired by a camera like the standard camera 40 cannot be applied without change to the image in which such a distortion occurs. Therefore, it is necessary to convert the acquired image into an image (a planar image) in which the distortion has been reduced, and then to use the image for the outside recognition.

In order to achieve appropriate driving assistance control or automated driving control, based on a recognition result of the outside of the vehicle 1, it is necessary to acquire precise information related to an object (for example, another vehicle, a pedestrian, a bicycle, a traffic signal, a road traffic sign, and the like) stationary or moving in the surroundings of the vehicle 1. Therefore, in the following embodiment, the control device 2 finds a specific object, the precise information of which should be acquired, from among the images that have been acquired by the fisheye cameras 41 to 44 (that is, determines where the specific object is present in the images). Furthermore, the control device 2 performs the distortion reduction process for reducing the distortion of the image on a partial area having the position of the object that has been found or its vicinity as the center (for example, the area 302 in FIG. 3) from among the images that have been acquired by the fisheye cameras 41 to 44. That is, the control device 2 sets a correction center point (for example, the correction center point 301 in FIG. 3) at the position of the object that has been found or in its vicinity, and performs the distortion reduction process. The control device 2 uses the image that has been acquired in this manner for the recognition process of recognizing the outside of the vehicle 1. This enables acquisition of more precise information related to the surrounding environment of the vehicle 1 through the recognition process. Note that, in the present specification, the vicinity of the position of the object means a position at which a desired outside recognition process for the target object is enabled by using the image that has been acquired by the distortion reduction process.

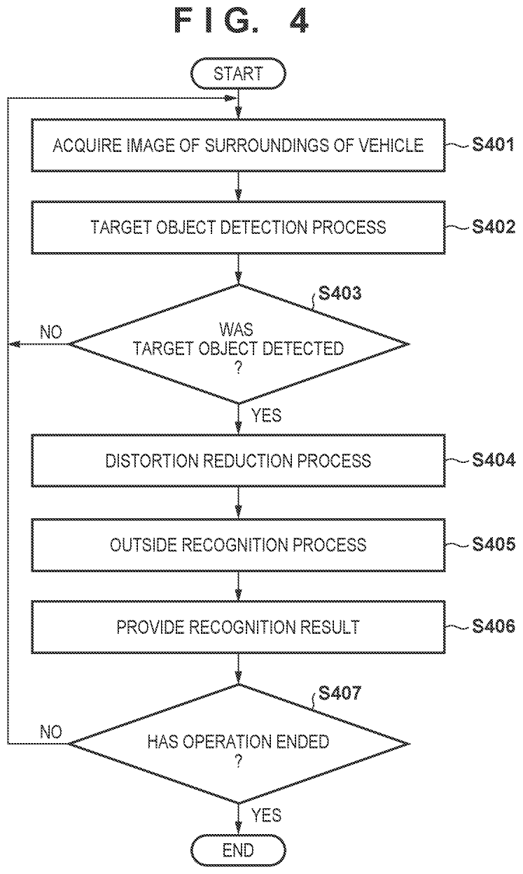

Hereinafter, an example of a method, by the control device 2, for controlling the vehicle 1 in some embodiments will be described with reference to FIG. 4. This method may be performed by the processor 20a of each of the ECUs 20 to 29 in the control device 2 executing a program in the memory 20b. The method of FIG. 4 may be started in response to a driving assistance function or an automated driving function by the control device 2 turning on.

In S401, the control device 2 acquires images of the outside of the vehicle 1 respectively from the standard camera 40 and the fisheye cameras 41 to 44. Each image includes the situation of the range that has been described in FIGS. 2A to 2C in the outside of the vehicle 1. Note that it is not necessary to perform the processes of S402 to S404 on the image that has been acquired from the standard camera 40.

In S402, the control device 2 performs a detection process of detecting an object (a target object) that has been predetermined as a detection target, based on the images that has been acquired from the respective fisheye cameras (the fisheye cameras 41 to 44). This detection process corresponds to a process of finding a specific object, the precise information of which should be acquired through the outside recognition, in the images that have been acquired. A target object to be detected can include, for example, one or more objects from another vehicle, a pedestrian, a bicycle, a traffic signal, and a road traffic sign.

As an example of the detection process, the control device 2 performs the image recognition on the images that have been acquired from the respective fisheye cameras so as to detect the target object. Such image recognition is achievable by using, for example, a model utilizing a known deep learning technique in which an image including the target object from among the images that have been acquired by the fisheye cameras is made to learn as teacher data. In a case where an unknown image is input, the learned model outputs the presence or absence of the target object in the image and an area (a position) of the target object. The learned model may be stored in the memory 20b beforehand. Note that the learned model is capable of outputting one or more areas in which the target object is present.

As another example of the detection process, the control device 2 may perform the image recognition on the image that has been acquired by dividing the image that had been acquired from each fisheye camera by a predetermined angle of view (for example, 120 degrees) so as to detect the target object. Accordingly, it becomes possible to find the target object in each divided image and to individually apply the distortion reduction process (S404) and the outside recognition process (S405) on the areas where the object that has been found is located. Accordingly, it becomes possible to appropriately acquire information related to an object present in a specific direction in the surroundings of the vehicle. Furthermore, as still another example, the control device 2 performs the image recognition on an image that has been acquired by performing the distortion reduction process once on the image that had been acquired from each fisheye camera, and so is also capable of detecting the target object.

Next, in S403 and S404, the control device 2 performs the distortion reduction process on the images that have been acquired from the respective fisheye cameras in accordance with a detection result of the detection process in S402. More specifically, in S403, the control device 2 determines whether the target object has been detected in the images that have been acquired from the respective fisheye cameras, in the detection process of S402. For each image corresponding to each fisheye camera, in a case where the target object is not detected, the control device 2 returns the process to S401, whereas in a case where the target object is detected, the control device 2 advances the process to S404.

In S404, the control device 2 performs the distortion reduction process on a partial area in the image that has been acquired from each fisheye camera, that is, the partial area having a detected position of the target object or its vicinity as the center. For example, the control device 2 sets the position where the target object has been detected in the image that had been acquired from each fisheye camera or a position in its vicinity as a correction center point (a conversion center position), cuts out a rectangular area having the correction center point as the center, and performs the distortion reduction process on the image that has been cut out. Accordingly, an image in which a distortion has been reduced is generated. Any existing technique may be used for the distortion reduction process, so its detailed description will be omitted.

When the conversion process in S404 is completed, the control device 2 performs, in S405, the recognition process of recognizing the outside of the vehicle 1, based on the image that has been acquired from the standard camera 40 and the image that has been acquired by the conversion process (the image in which the distortion has been reduced). Similarly to S402, the recognition process is achievable by utilizing a model acquired by making an image including the target object from among the images that have been acquired by the fisheye cameras learned as teacher data, for example, by utilizing a known deep learning technique. The learned model may be stored in the memory 20b beforehand. Note that the learned model is capable of outputting one or more areas in which the target object is present.

When the recognition process is completed, information related to the object that has been extracted by the recognition process is supplied for the driving assistance control or the automated driving control. That is, the control device 2 may control the vehicle 1 (for example, automated brake, a notification to the driver, a change of automated driving level, and the like) in accordance with a recognition result of the outside. Any existing technique may be applied to the control of the vehicle 1 in accordance with the recognition result of the outside, so its detailed description will be omitted.

Then, in S407, the control device 2 determines whether to end the operation. In a case of determining ending of the operation, the control device 2 ends the operation. In the other case, the process returns to S401 to repeat the above-described process. The control device 2 may determine to end the operation, in response to, for example, the driving assistance function or the automated driving function turning off.

As described above, the processes of S401 to S407 are repeatedly performed. The control device 2 may periodically performs the processes of S401 to S407. This cycle of performance varies depending on the period of time necessary for the detection process in S402, the distortion reduction process in S404, and the recognition process in S405, and may be, for example, approximately 100 ms.

As described heretofore, in the present embodiment, the control device 2 (the ECUs 22 and 23) acquires the images that have been acquired by imaging the outside of the vehicle 1 from the imaging devices (the fisheye cameras), and detects the target object through the image recognition, based on the images that have been acquired from the imaging devices. Furthermore, in accordance with the detection result of the target object (for example, the presence or absence of the target object detected), the control device 2 performs the distortion reduction process for reducing a distortion in the image, on a partial area in the image that has been acquired from the imaging device, that is, on the partial area having the detection position of the target object or the position in its vicinity as the center. The control device 2 recognizes the outside of the vehicle 1, based on the image that has been acquired by the distortion reduction process. Accordingly, it becomes possible to accurately acquire information related to the object in the surroundings of the vehicle 1 from the images acquired by the imaging devices (the fisheye cameras) each of which is attached with the fisheye lens.

<Modifications>

In some embodiments described above, it is assumed that an object to be found (detected) in an image acquired from a fisheye camera is determined beforehand. On the other hand, in another embodiment, the object to be a detection target may be determined based on an operation state of the vehicle 1 (for example, for each traveling scene of the vehicle 1).

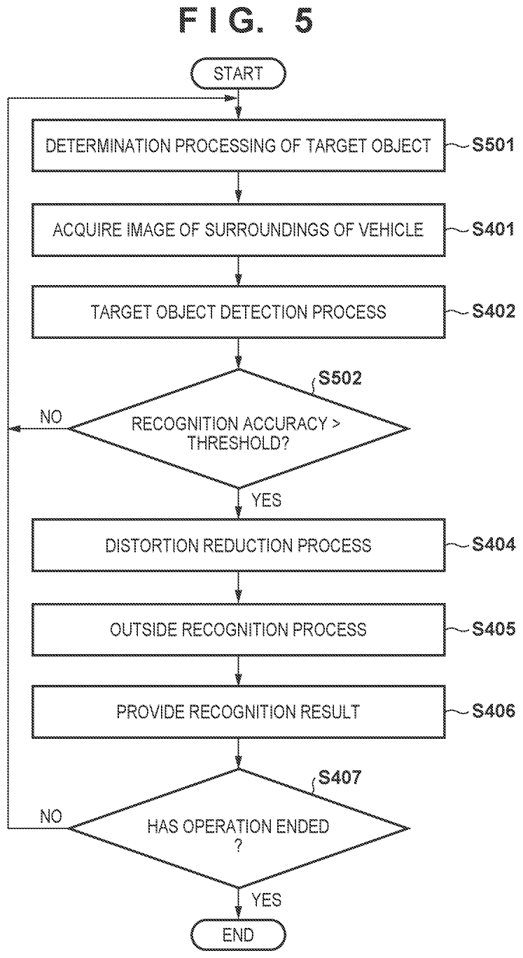

An example of a method, by the control device 2, for controlling the vehicle 1 in another embodiment will be described with reference to FIG. 5. Similarly to the method of FIG. 4, this method may be performed by the processor 20a of each of the ECUs 20 to 29 in the control device 2 executing a program in the memory 20b. The method of FIG. 4 may be started in response to a driving assistance function or an automated driving function by the control device 2 turning on. Note that, in the following, for simplification of description, the description of the process similar to the process in the method of FIG. 4 will be omitted.

In S501, the control device 2 determines an object to be detected in the object detection process (S402), based on an operation state of the vehicle 1. The operation state may be a traveling scene of the vehicle, or may be a driving state of the vehicle (for example, the automated driving level). For example, in nations where traveling on the left is adopted, in a case where a traveling scene of the vehicle 1 corresponding to an operation state of the vehicle 1 is a scene in which the vehicle 1 turns to the right at an intersection, the control device 2 may determine an oncoming vehicle traveling in an opposite lane as an object to be a detection target. In addition, in a case where the traveling scene of the vehicle 1 corresponding to the operation state of the vehicle 1 is a scene in which the vehicle 1 turns to the left at an intersection, the control device 2 may determine a traffic participant (a pedestrian, a bicycle, another vehicle, and the like) that may cause a collision accident at the time of turning to the left, as the object to be the detection target.

After determining the target object, the control device 2 acquires, in S401, the images of the outside of the vehicle 1 respectively from the standard camera 40 and the fisheye cameras 41 to 44, similarly to the method of FIG. 4, and advances the process to S402. Note that, in the present example, the process of S501 is performed before the process of S401. However, the process of S501 may be performed after the process of S401. In S402, the control device 2 performs the detection process of detecting the target object, based on the images that have been acquired from the respective fisheye cameras (the fisheye cameras 41 to 44), similarly to the method of FIG. 4. However, in the present example, the detection target in the detection process is the object determined in the process of S501. Furthermore, for example, as an output indicating the presence or absence of the target object in the images that have been acquired by the respective fisheye cameras in accordance with the above-described learned model, information indicating the recognition accuracy of the target object through the image recognition is output.

After completion of the detection process, the control device 2 determines, in S502, whether the recognition accuracy of the target object through the image recognition in the detection process performed in S402 is higher than an accuracy threshold. In a case where the recognition accuracy is higher than the accuracy threshold, the control device 2 determines that the target object has been detected, and advances the process to S404. In the other case, the control device 2 returns the process to S401.

Here, the accuracy threshold may be determined beforehand for each operation state of the vehicle 1, or may be determined beforehand for each type of the object to be detected in the detection process (S402). In S501, the control device 2 in the present embodiment determines (selects) the accuracy threshold to be used in S502 in accordance with the operation state of the vehicle 1 or the type of the object that has been determined as the detection target (based on the operation state). For example, for the type of an object having high importance of detection on a certain traveling scene, the corresponding accuracy threshold may be set to be low so that it is more likely to determine that the object has been detected in S502 (so that the distortion reduction process and the recognition process are more likely to be performed). On the other hand, for the type of an object having low importance of detection, the corresponding accuracy threshold may be set to be high so that the distortion reduction process and the recognition process are less likely to be performed. This enables an efficient reduction in a calculation amount accompanied with the distortion reduction process and the recognition process.

In S404 to S407, the control device 2 performs a process similar to the method of FIG. 4.

As described above, according to the present embodiment, the object to be the detection target is determined, based on the operation state of the vehicle 1, so that it becomes possible to appropriately acquire information related to an object of a type that needs to be detected to correspond to the operation state of the vehicle from the images that have been acquired by the fisheye cameras. In addition, it becomes possible to be more likely to perform the recognition process by performing the distortion reduction process on the object having high importance of detection, whereas it becomes possible to perform neither the distortion reduction process nor the recognition process on the object having low importance of detection. This enables a reduction in the calculation amount accompanied with the distortion reduction process and the recognition process. In addition, the accuracy threshold to be compared with the recognition accuracy of image recognition in the object detection process is changed in accordance with the operation state of the vehicle 1 or the type of the object that has been determined as the detection target, and so it becomes possible to efficiently reduce the amount calculated accompanied with the distortion reduction process and the recognition process.

### Other Embodiment

In addition, a program for achieving one or more functions that have been described in each embodiment is supplied to a system or an apparatus through a network or a storage medium, and one or more processors in a computer of the system or the apparatus are capable of reading and executing such a program. The present invention is also achievable by such an aspect.

### Summary of Embodiments

The above embodiments disclose at least the following embodiments.

Item 1. A control device (e.g., 2) of a mobile object (e.g., 1) including an imaging device (e.g., 41-44) attached with a lens having a wide angle of view, the control device comprising:

an image acquisition unit configured to acquire, from the imaging device, an image (e.g., 300) that has been acquired by imaging an outside of the mobile object;

a detection unit configured to detect a target object through image recognition, based on the image acquired from the imaging device;

a processing unit configured to perform a distortion reduction process for reducing a distortion of the image on a partial area (e.g., 302) in the image acquired from the imaging device, in accordance with a detection result of the detection unit, the partial area being an area whose center is set to be either a detection position of the target object or a vicinity of the detection position; and

a recognition unit configured to recognize the outside of the mobile object, based on an image (e.g., 303) that has been acquired by the distortion reduction process.

According to this item, it becomes possible to accurately acquire information related to the object in the surroundings of the mobile object from the image acquired by the imaging device attached with a lens having a wide angle of view.

Item 2. The control device according to Item 1, wherein

the processing unit performs the distortion reduction process, when the detection unit detects the target object.

According to this item, it becomes possible to appropriately perform the distortion reduction process in accordance with the detection result of the target object.

Item 3. The control device according to Item 1 or 2, wherein

the detection unit detects the target object by performing the image recognition on the image that has been acquired from the imaging device.

According to this item, it becomes possible to detect the target object without the need for additional processing on the image that has been acquired by the imaging device, and to suppress a processing load.

Item 4. The control device according to Item 1 or 2, wherein

the detection unit detects the target object by performing the image recognition on an image acquired by dividing the image that has been acquired from the imaging device by a predetermined angle of view.

According to this item, it becomes possible to appropriately acquire information related to an object present in a specific direction.

Item 5. The control device according to Item 1 or 2, wherein

the detection unit detects the target object by performing the image recognition on an image acquired by performing the distortion reduction process on the image that has been acquired from the imaging device.

According to this item, it becomes possible to achieve the image recognition for detecting the target object with use of a model that has been prepared for an image with less distortion, such as the image captured by the standard camera 40.

Item 6. The control device according to any one of Items 1-5, further comprising

a determination unit configured to determine an object to be detected by the detection unit, based on an operation state of the mobile object.

According to this item, it becomes possible to appropriately acquire information related to an object of a type that needs to be detected to correspond to the operation state of the mobile object.

Item 7. The control device according to Item 6, wherein

the detection unit outputs information indicating recognition accuracy of the target object through the image recognition, and

the processing unit performs the distortion reduction process, in a case where the recognition accuracy indicated by the information is higher than a threshold.

According to this item, it becomes possible to appropriately control whether to perform the distortion reduction process and the recognition process, based on the recognition accuracy of the target object in the detection process, and to efficiently reduce the amount necessary for calculation.

Item 8. The control device according to Item 7, wherein

the threshold is determined beforehand for each type of the object to be detected by the detection unit, and

the processing unit performs the distortion reduction process, in a case where the recognition accuracy indicated by the information is higher than the threshold corresponding to the object that has been determined by the determination unit.

According to this item, it becomes possible to efficiently reduce the amount calculated accompanied with the distortion reduction process and the recognition process.

Item 9. The control device according to Item 7, wherein

the threshold is determined beforehand for each operation state of the mobile object, and

the processing unit performs the distortion reduction process, in a case where the recognition accuracy indicated by the information is higher than the threshold corresponding to the operation state.

According to this item, it becomes possible to efficiently reduce the amount calculated accompanied with the distortion reduction process and the recognition process.

Item 10. The control device according to any one of Items 1-9, wherein the imaging device is an imaging device attached with a fisheye lens.

According to this item, it becomes possible to accurately acquire information related to the object in the surroundings of the mobile object from the image acquired by the imaging device attached with a fisheye lens.

Item 11. The control device according to any one of Items 1-10, wherein

the mobile object includes a plurality of imaging devices respectively disposed in a front part, a rear part, and a lateral part of the mobile object, and

the image acquisition unit acquires images respectively from the plurality of imaging devices.

According to this item, it becomes possible to accurately acquire information related to an object in the surroundings in all directions around the vehicle.

Item 12. The control device according to any one of Items 1-11, wherein the mobile object is a vehicle.

According to this item, it becomes possible to accurately acquire information related to the object in the surroundings of the vehicle from the image acquired by the imaging device attached with a fisheye lens.

Item 13. A method for controlling a mobile object (e.g., 1) including an imaging device (e.g., 41-44) attached with a lens having a wide angle of view, the method comprising:

acquiring, from the imaging device, an image (e.g., 300) that has been acquired by imaging an outside of the mobile object;

detecting a target object through image recognition, based on the image acquired from the imaging device;

performing a distortion reduction process for reducing a distortion of the image on a partial area (e.g., 302) in the image acquired from the imaging device, in accordance with a detection result in the detecting, the partial area being an area whose center is set to be either a detection position of the target object or a vicinity of the detection position; and

recognizing the outside of the mobile object, based on an image (e.g., 303) that has been acquired by the distortion reduction process.

According to this item, it becomes possible to accurately acquire information related to the object in the surroundings of the mobile object from the image acquired by the imaging device attached with a lens having a wide angle of view.

Item 14. A program for causing a computer to function as each unit of the control device any one of Items 1-12.

According to this item, the above effect is obtainable in the form of a program.

The invention is not limited to the foregoing embodiments, and various variations/changes are possible within the spirit of the invention.

What is claimed is:

1. A control device of a mobile object including an imaging device attached with a lens having a wide angle of view, the control device comprising:
an image acquisition unit configured to acquire, from the imaging device, an image that has been acquired by imaging an outside of the mobile object;
a detection unit configured to detect a target object through image recognition, based on the image acquired from the imaging device;
a processing unit configured to perform a distortion reduction process for reducing a distortion of the image on a partial area in the image acquired from the imaging device, in accordance with a detection result of the detection unit, the partial area being an area whose center is set to be either a detection position of the target object or a vicinity of the detection position; and
a recognition unit configured to recognize the outside of the mobile object, based on an image that has been acquired by the distortion reduction process.

2. The control device according to claim 1, wherein
the processing unit performs the distortion reduction process, when the detection unit detects the target object.

3. The control device according to claim 1, wherein
the detection unit detects the target object by performing the image recognition on the image that has been acquired from the imaging device.

4. The control device according to claim 1, wherein
the detection unit detects the target object by performing the image recognition on an image acquired by dividing the image that has been acquired from the imaging device by a predetermined angle of view.

5. The control device according to claim 1, wherein
the detection unit detects the target object by performing the image recognition on an image acquired by performing the distortion reduction process on the image that has been acquired from the imaging device.

6. The control device according to claim 1, further comprising
a determination unit configured to determine an object to be detected by the detection unit, based on an operation state of the mobile object.

7. The control device according to claim 6, wherein
the detection unit outputs information indicating recognition accuracy of the target object through the image recognition, and
the processing unit performs the distortion reduction process, in a case where the recognition accuracy indicated by the information is higher than a threshold.

8. The control device according to claim 7, wherein
the threshold is determined beforehand for each type of the object to be detected by the detection unit, and
the processing unit performs the distortion reduction process, in a case where the recognition accuracy indicated by the information is higher than the threshold corresponding to the object that has been determined by the determination unit.

9. The control device according to claim 7, wherein
the threshold is determined beforehand for each operation state of the mobile object, and
the processing unit performs the distortion reduction process, in a case where the recognition accuracy indicated by the information is higher than the threshold corresponding to the operation state.

10. The control device according to claim 1, wherein the imaging device is an imaging device attached with a fisheye lens.

11. The control device according to claim 1, wherein
the mobile object includes a plurality of imaging devices respectively disposed in a front part, a rear part, and a lateral part of the mobile object, and
the image acquisition unit acquires images respectively from the plurality of imaging devices.

12. The control device according to claim 1, wherein the mobile object is a vehicle.

13. A method for controlling a mobile object including an imaging device attached with a lens having a wide angle of view, the method comprising:
acquiring, from the imaging device, an image that has been acquired by imaging an outside of the mobile object;
detecting a target object through image recognition, based on the image acquired from the imaging device;
performing a distortion reduction process for reducing a distortion of the image on a partial area in the image acquired from the imaging device, in accordance with a detection result in the detecting, the partial area being an area whose center is set to be either a detection position of the target object or a vicinity of the detection position; and
recognizing the outside of the mobile object, based on an image that has been acquired by the distortion reduction process.

14. A non-transitory computer-readable storage medium storing a program for causing a computer to function as each unit of the control device according to claim 1.
